(19) United States
(12) Patent Application Publication
(10) Pub. No.: US 2006/0078306 A1
(43) Pub. Date: Apr. 13, 2006

(54) Image-and-audio data real-time integration system of an image-and-Audio data storage device

(76) Inventors: Wei-Hung Wen, Hsin-Tien City (TW); Yi-Yi Chen, Hsin-Tien City (TW)

Correspondence Address: RABIN & BERDO, P.C., Suite 500, 1101 14 Street, N.W., Washington, DC, 20005, US

(21) Appl. No.: 11/242,867

(22) Filed: Oct. 5, 2005

(30) Foreign Application Priority Data
Oct. 12, 2004 (TW) 93130911
Nov. 15, 2004 (TW) 93134864

(51) Int. Cl. H04N 5/76; H04N 5/225

(52) U.S. Cl. 386/96; 386/117

(57) ABSTRACT

The present invention relates to an image-and-audio data real-time integration system for integrating an image data and an audio data into an image-and-audio integrated data, and has an image data parser, an audio data parser, and an image-and-audio data integrating processor. The image data parser retrieves image data from an image source and stores the image data in an image data buffer. The audio data parser retrieves the audio data from an audio source and stores the audio data in an audio data buffer. The image-and-audio data integrating processor integrates the image data and the audio data into the image-and-audio integrated data.

### RELATED APPLICATIONS

The present application is based on, and claims priority from, Taiwan Application Serial Number 93130911, filed Oct. 12, 2004; and Taiwan Application Serial Number 93134864, filed Nov. 15, 2004, the disclosure of which is hereby incorporated by reference herein in its entirety.

### BACKGROUND

1. Field of Invention

The present invention relates to an image-and-audio data integration system and method. More particularly, the present invention relates to an image-and-audio data real-time integration system and method for improving an image-reviewing interface.

2. Description of Related Art

Due to the limited storage capacity, image data retrieved by an image-retrieving device, such as a digital camera, or a mobile phone equipped with camera, must be further transferred to a storage medium for long-term storage. The widely adapted approach is to record image data on a VCD or a DVD by an image-and-audio data storage device, such as a CD-R drive, a CD-RW drive, a DVD-RW drive, or the like. Alternatively, image data can also be stored on a hard disk.

However, the conventional image and audio data storage device can only perform related recording procedure rather than edit multimedia data because of the limitations of capability. That is, a user cannot add audio data, such as commentary or background music, to the image data ready for recording when employing the conventional image-and-audio data storage device. As a result, the user can only review soundless images, which makes the reviewing process less entertaining.

If the user desires to add the audio data to a ready-for-recording image data as described above, a personal computer is usually used to perform the image data and the audio data integration procedure. Besides, the user has to follow a complicated editing procedures provided by associated multimedia software for integration. To use the additional personal computer for the data integration significantly increases the cost and process efforts. Besides, the conventional editing process is time-consuming and inaccessible because the user may be unfamiliar with the editing procedure and/or personal computer operations. Although the conventional editing process provides the image data and words of illustrating the image data thereon, those additional words of may affect a visual effect of the image data.

### SUMMARY

An image-and-audio data real-time integration system is proposed for integrating an audio data and a previously captured image data in an image-and-audio integrated data storage device. The disclosed audio-and-image data real-time integration system includes an image data parser, an audio data parser, and an audio-and-image data integration processor. The image parser retrieves the previously captured image data from an image source and then stores the image data in an image data buffer. The audio data parser retrieves an audio data from an audio data source and then stores the audio data in an audio data buffer. The image-and audio-data integration processor retrieves the image data from the image data buffer and the audio data from the audio data buffer, and then integrates the audio data and the image data into an image-and-audio integrated data.

In another embodiment, an image-and-audio integrated data storage device for integrating audio data and a previously captured image data into an image-and-audio integrated data and for recording the image-and-audio integrated data in a storage medium is proposed. The image-and-audio data storage device includes an image data parser, an audio data parser, an image-and-audio data integration processor, and a storage controller. The image data parser retrieves the image data from an image data source and stores the image data in an image data buffer. The audio data parser retrieves the audio data from an audio data source and stores the audio data in an audio data buffer. The image-and-audio data integration processor retrieves the image data from the image data buffer and the audio data from the audio data buffer, and then integrates the image data and the audio data into an image-and-audio integrated data. The storage controller receives the image-and-audio integrated data from the image-and-audio data integration processor and stores the image-and-audio integrated data in an external storage medium.

In yet another embodiment, the disclosed image-and-audio integrated data storage device further includes an image data decoder, and a video data encoder. The image data decoder receives the image data from the image data parser and decodes the image data. The video data encoder receives the decoded image data from the image data decoder and encodes the decoded image data according to a display format of a display device coupled with the image-and-audio data storage device.

In a still another embodiment, an image-and-audio data real-time integration method for integrating an audio data and a previously captured image data into an image-and-audio integrated data for an image-and-audio integrated data storage device is proposed. First, a previously captured image data from an image data source and the audio data from an audio data source are respectively retrieved from where the image data and the audio data are stored. Next, the previously captured image data and the audio data are integrated into the image-and-audio integrated data in the image-and-audio data storage device.

The image-and-audio integrated data storage device according to the present invention enables a user to add or attach audio data, such as commentary or background music in the previously acquired image data when preparing to record soundless image data on a storage medium in the image-and-audio integrated data storage device without any assistance from a personal computer. The image data can be instantly stored with audio data, and the entertainment effects thereof can be enhanced because the user may play and modify the integrated data as his/her requirements.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a block diagram illustrating an image-and-audio data real-time integration system according to the present invention;

FIG. 2 is a block diagram illustrating the image-and-audio integrated data storage device according to the present invention;

FIG. 3 is a flowchart illustrating the image-and-audio data integrating method according to the present invention; and

FIG. 4 is a block diagram illustrating the DVD recorder according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The image-and-audio integrated data storage device according to the present invention can add or attach audio data, such as commentary or background music, to a previously captured image data ready for being stored on an image-and-audio integrated data storage device, such as a DVD, or VCD. Any user uses the image-and-audio integrated data storage device embedded the disclosed real-time integration system may be pleased because he/she may integrate an audio data with his/her previously captured image data in the disclosed storage device without any assistance from a personal computer.

The present invention provides an image-and-audio data real-time integration system used for an optical device by adding the audio data (such as voice or speech) instead of the illustrating words superposed on the image data directly. The user can review the whole image data without any affection arisen from the superposed words. The present invention further provides the audio data (such as music) ready-for-appending to the image data for entertainment.

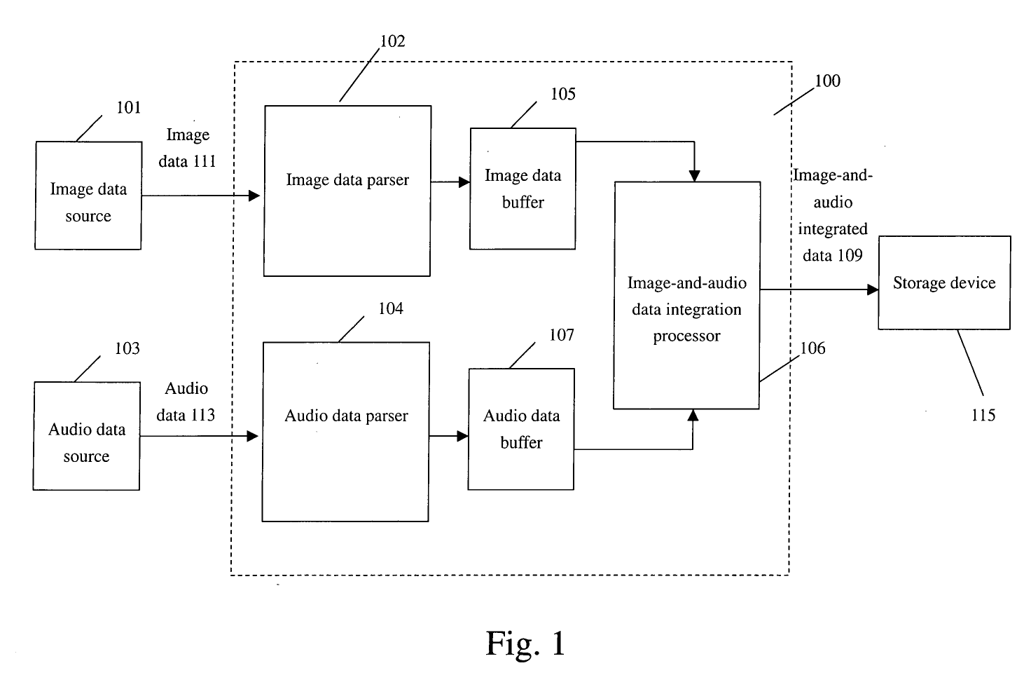

FIG. 1 is a block diagram illustrating the image-and-audio data real-time integration system according to the present invention. The image-and-audio data real-time integration system 100 includes an image data parser 102, an audio data parser 104, an image-and-audio data integration processor 106, and a storage device 115. The image data parser 102 retrieves a previously captured image data 111 ready for being recorded from an image data source 101. The audio data parser 104 retrieves an audio data 113 ready for being integrated with the image data 111 from an audio data source 103. The image data parser 102 can be, for example, a memory card reader of a digital camera, while the audio data parser 104 can be configured by an audio card and corresponding software. It is noted that the image data 111 and the audio data 113 are not captured at the same time. In other words, the image data source 101 and the audio data source 103 are derived independent. Usually, the image data 111 are first retrieved and then the audio data 113 added therein in the embodiment because a user may decide what to add before he/she begins to record the image data. For example, the user may capture an image at a high spot by using a digital camera. He/She may input speeches to introduce where he/she is or just tell how he/she feels now. A microphone embedded in the digital camera may receive the speeches and then integrates the received speeches with the previously captured image together. He/She might preview the integration effect and decide to delete or store the integration result. Additionally, the user may input speeches into a DVD recorder embedded with a microphone. A portable storage device such as a flash card may be an image data resource for providing images captured in a hot spot previously. In operation, he/she may input speeches after he/she selects an image from the image data resource. He/She may employ a digital camera without the disclosed integration function to capture images in advance, and then integrates a select image from the digital camera with input speeches by means of any optical recording device (such as a DVD-Recorder) configured with the disclosed function. This optical recording device may record the image integrated with the input speeches into a DVD after his/her favorite speeches are made. Please note that any optical disc device having data-recording function, such as DVD-Recorder, DVD-RW, CD-RW, or CD-R, may configure the disclosed invention to integrate speech or the like with a previously captured image. Any person having ordinary skills in the art may modify the embodiments as requirements but any similar modification or variation within the spirits of the embodiment should be included in the appended claims.

The image data 111 retrieved by the image data parser 102 and the audio data 113 retrieved by the audio data parser 104 are stored in an image data buffer 105 and an audio data buffer 107, respectively. Subsequently, the image data 111 and the audio data 113 will be further transferred to the image-and-audio data integration processor 106 for the sake of integration. The image data buffer 105 and the audio data buffer 107 can be optional if the image-and-audio data integration processor 106 is capable of performing real-time integration. The image-and-audio data integration processor 106 integrates the image data 111 and the audio data 113 into an image-and-audio integrated data 109 by means of a format used for encoding multimedia data such that the integrated data derived by the embodiment should be portable and accessible by another compatible devices such as PCs and DVD-/VCD-related drives or players. For example, the well-known MPEG format could be used for storing the image-and-audio integrated data 109. In implementation, the previously captured image could the only one I frame while the input speeches and/or audio could be encoded based on the employed MPEG specification. Therefore the image-and-audio integrated data 109 could be played in any device or system which is capable of recognizing and decoding files encoded by the MPEG spec. The image-and-audio integrated data 109 is then transferred to the storage controller of the image-and-audio integrated data storage device 115, for example, a recording controller of a recording device, for storage.

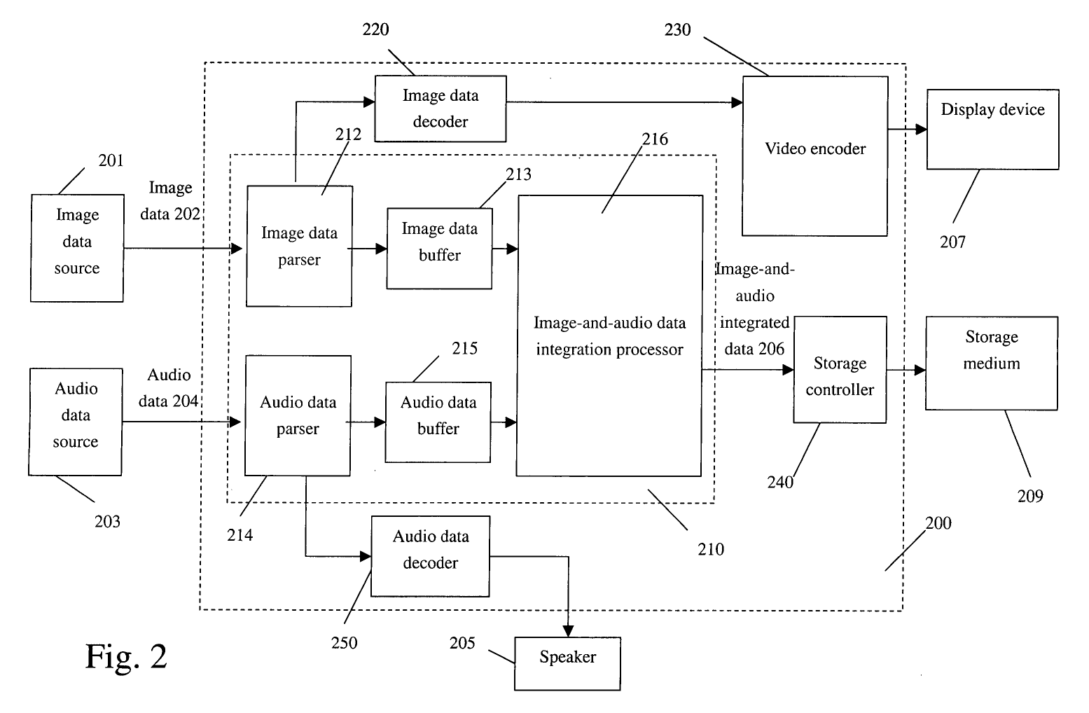

FIG. 2 is a block diagram illustrating the image-and-audio integrated data storage device according to the present invention. The image-and-audio integrated data storage device 200 includes an image-and-audio data integration system 210 and a storage controller 240, such as a recording controller which may be configured by using the control chip of the image-and-audio integrated data storage device 200. The image-and-audio integrated data storage device 200 further includes an image data decoder 220, and a video encoder 230. The image-and-audio data integration system 210 used for integrating the image data 202 and the audio data 204 further includes an image data parser 212, an audio data parser 214, and an image-and-audio data integration processor 216.

The image data parser 212 retrieves the image data 202 to be stored from an image data source 201, while the audio data parser 214 retrieves the audio data 204 ready for being added with the image data 202 from an audio data source 203. It is noted that the image data 202 previously captured, and the audio data 204 retrieved afterwards are to be integrated together. Therefore, the image data source 201 and the audio data source 203 are generated independently. In one embodiment, the audio data source 203 is a microphone input or an audio input.

The image data 202 and the audio data 204 are stored in an image data buffer 213 and an audio data buffer 215, respectively. The image data buffer 213 and the audio data buffer 215 provide buffer capability if the image-and-audio data integration processor 216 cannot integrate the image data 202 and the audio data 204 instantly. However, the image data buffer 213 and the audio data buffer 215 can be optional if the image-and-audio data integration processor 216 can integrate the image data 202 and the audio data 204 in real time. In this embodiment, the image data buffer 213 and the audio data buffer 215 are memory cards, hard disks, flash memories, random access memories, or the like.

Next, the image-and-audio data integration processor 216 retrieves the image data 202 and the audio data 204 from the image data buffer 213 and the audio data buffer 215 correspondingly. Alternatively, if the image data buffer 213 and the audio data buffer 215 are not employed, the image-and-audio data integration processor 216 retrieves the image data 202 and the audio data 204 from the image data parser 212 and the audio data parser 214, respectively. The image-and-audio data integration processor 216 receives at least one command and integrates the image data 202 and the audio data 204 into an image-and-audio integrated data 206 according to the indication of the command. Any skill known in the art for integrating the image data and the audio data into multimedia data can be employed. The image-and-audio integrated data 206 is further transferred to a storage controller 240 for storing on a storage medium 209, such as an external storage medium. The storage medium 209 may be a VCD or DVD.

Besides, the image-and-audio integrated data storage device 200 can also play the image data 202 and the audio data 204 so that the user can review the image data 202 and the audio data 204 during the integration process, and/or the image-and-audio integrated data 206 after the integration process is completed.

The image data 202 retrieved by the image data parser 212 is transferred to the image data decoder 220 for decoding, and is further encoded by the video data encoder 230 into a display signal for displaying on a display device 207. The audio data 204 retrieved by the audio data parser 214 is transferred to an audio data decoder 250 for decoding into an audio signal and then playing through a speaker 205. The image data are, for example, JPEG image data, or the like, and the audio data is a speech, voice-over, background music, or the like. Furthermore, the image-and-audio integrated data storage device 200 is a CD-RW drive, VCD recorder, DVD recorder, or the like.

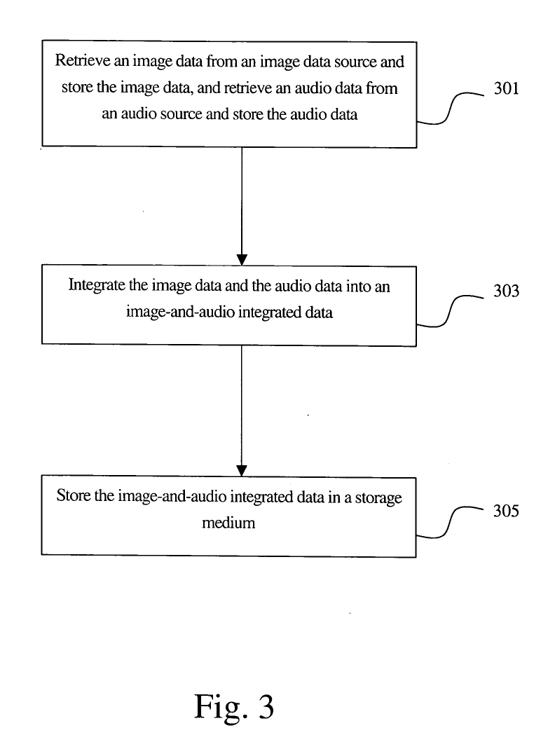

FIG. 3 is a flowchart illustrating the image-and-audio data integration method according to the present invention. The image-and-audio data integration method is employed in a multimedia device for integrating an audio data into a previously captured image data. First, the image data are retrieved from an image data source, and then audio data are retrieved from an audio data source (step 301). The image data and the audio data are stored if necessary. Next, the image data and the audio data are integrated into an image-and-audio integrated data (step 303). Further, the image-and-audio integrated data are stored on a storage medium (step 305).

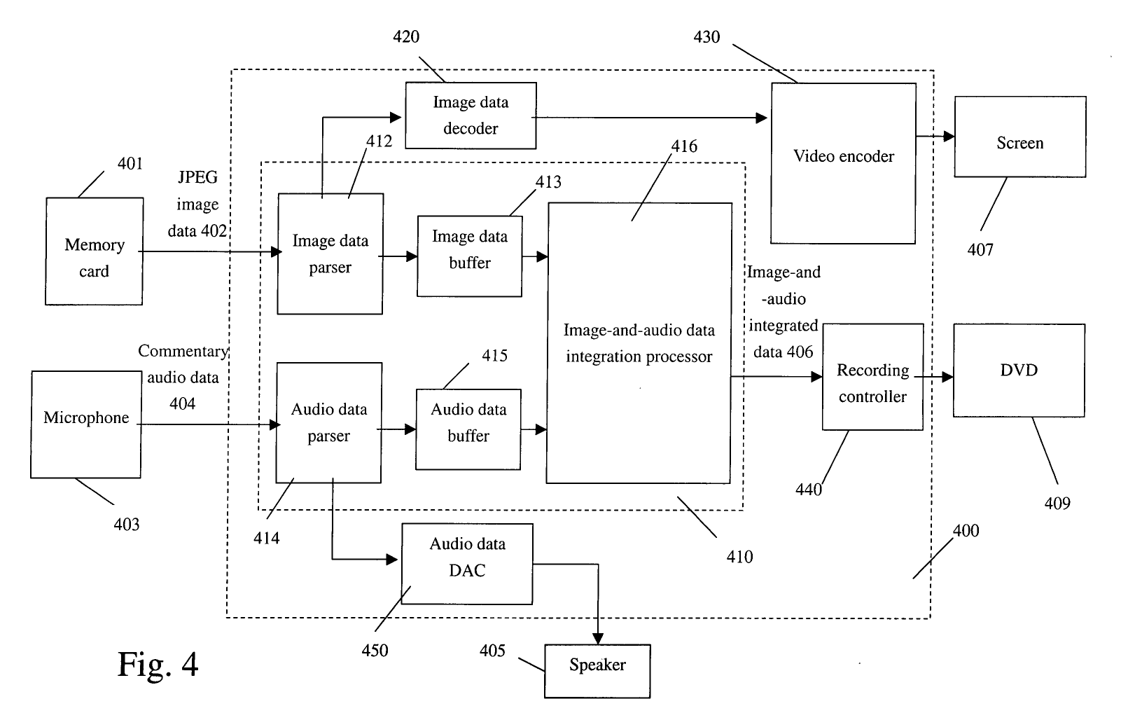

FIG. 4 is a block diagram illustrating the DVD recorder according to one preferred embodiment of the present invention. The DVD recorder 400 includes an image-and-audio data integration system 410, an image data decoder 420, a video encoder 430, and a recording controller 440. The image-and-audio data integration system 410 is used for integrating the JPEG image data 402 and the commentary audio data 404. The image-and-audio data integration system 410 includes an image data parser 412, an audio data parser 414, and an image-and-audio data integration processor 416. A person having ordinary skill in the art knows that any image encoded by another format such as TIFF and BMP could be employed in the disclosed DVD recorder 400, and any modification within the spirits of the embodiment should be included in the appended claims.

When the user uses the DVD recorder 400 for recording the JPEG image data 402, the image data storage device, such as a memory card 401 within the JPEG image data 402 stored thereon, is connected to the DVD recorder 400. The image data parser 412 retrieves the JPEG image data 402 to be recorded from the memory card 401, and stores the JPEG image data 402 in image data buffer 413.

Meanwhile, the JPEG image data 402 is transferred to the image data decoder 420 for decoding. The JPEG image data 402 is further encoded by the video encoder 430 and displayed on a screen 407. Therefore, the user can review the JPEG image data 402 stored in the memory card 401, and determine where the commentary to be added at the same time.

When the user is reviewing the JPEG image data 402, the commentary audio data 404 can be added via the microphone 403. The audio data parser 414 retrieves the commentary audio data 404 from the microphone and stores the same in the audio data buffer 415. Next, the image-and-audio data integration processor 416 retrieves the JPEG image data 402 stored in the image data buffer 412, and the commentary audio data 404 stored in the audio data buffer 415, and then integrates them into an image-and-audio integrated data 406.

The image-and-audio integrated data 406 is further transferred to the recording controller 440 for recording on a DVD 409. Besides, the commentary audio data 404 retrieved by the audio data parser 414 are transferred to the speaker 405.

The image and audio data storage device according to the present invention enables the user to add an audio data, such as commentary or background music, while storing soundless image data to a storage medium. A personal computer and complicated editing processes are no longer required. The image data can be stored with the audio data instantly, and the entertainment effects thereof can be enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image-and-audio data real-time integration system in an optical device for integrating an audio data within an image data previously captured into an image-and-audio integrated data, the image-and-audio data real-time integration system comprising:
an image data parser for retrieving the image data previously captured from an image data source;
an audio data parser for retrieving the audio data from an audio data source; and
an image-and-audio data integration processor for integrating the image data and the audio data into the image-and-audio integrated data.

2. The image-and-audio data real-time integration system of claim 1, wherein the audio data is retrieved after the image data is retrieved.

3. The image-and-audio data real-time integration system of claim 1, wherein the image-and-audio data integration processor accepts at least one command and integrates the image data and the audio data based upon the at least one command.

4. The image-and-audio data real-time integration system of claim 1, further comprising:
image data buffer for storing the image data;
audio data buffer for storing the audio data; and
an image-and-audio integrated data storage device for storing the image and audio integrated data.

5. The image-and-audio data real-time integration system of claim 4, wherein the image data buffer is a memory card, a hard disk, a flash memory, or a random access memory.

6. The image-and-audio data real-time integration system of claim 1, wherein the audio data source is a microphone input and a voice input.

7. The image-and audio-data real-time integration system of claim 1, an image data decoder is connected to the image data parser for decoding the image data.

8. The image-and-audio data real-time integration system of claim 7, a video encoder is connected to the image data decoder for displaying to a displaying screen.

9. An optical device for integrating audio data and image data previously acquired into an image-and-audio integrated data, and for recording the image-and-audio integrated data in an external storage medium, the optical device comprising:
an image data parser for retrieving the image data from an image data source and for storing the image data in an image data buffer;
an audio data parser for retrieving the audio data from an audio data source and for storing the audio data in an audio data buffer;
an image-and-audio data integrating processor for retrieving the image data from the image data buffer and the audio data from the audio data buffer, and for integrating the image data and the audio data into the image-and-audio integrated data; and
a storage controller for receiving the image-and-audio integrated data from the image-and-audio data integration processor, and for recording the image-and-audio integrated data to the external storage medium.

10. The optical device of claim 9, wherein the audio data source and the image data source are independent.

11. The optical device of claim 10, wherein the audio data are retrieved by the optical device after the image data are retrieved by the optical device.

12. The optical device of claim 9, further comprising an image data decoder and a video data encoder, wherein the image data decoder receiving the image data from the image data parser and decoding the image data into the decoded image data, and the video data encoder receiving the decoded image data from the image data decoder and encoding the decoded image data into a display signal sent to a display device.

13. An image-and-audio data integration method employed in an optical device for integrating audio data and image data previously captured into an image-and-audio integrated data, the image-and-audio data integration method comprising the steps of:
retrieving the image data from an image data source and storing the image data, and retrieving the audio data from an audio data source and storing the audio data; and
retrieving the image data and the audio data, and integrating the image data and the audio data into the image-and-audio integrated data.

14. The image-and-audio data integrating method of claim 13, wherein the audio data source and the image data source are independent.

15. The image-and-audio data integrating method of claim 13, wherein the image data is retrieved before the audio data .

16. The image-and-audio data integrating method of claim 13, further comprising storing the image-and-audio integrated data on a storage medium.
